(19) United States
(12) Patent Application Publication
(10) Pub. No.: US 2018/0063206 A1
(43) Pub. Date: Mar. 1, 2018

(54) Media Communication

(71) Applicant: Microsoft Technology Licensing, LLC, Redmond, WA (US)

(72) Inventors: Jason Thomas Faulkner, Seattle, WA (US); Casey James Baker, Seattle, WA (US)

(73) Assignee: Microsoft Technology Licensing, LLC, Redmond, WA (US)

(21) Appl. No.: 15/253,205

(22) Filed: Aug. 31, 2016

(51) Int. Cl. H04L 29/06; G06F 3/0482

(52) U.S. Cl. CPC H04L 65/403; G06F 2203/04803; G06F 3/0482

(57) ABSTRACT

A method and apparatus for providing communication between participants of a shared user event, in which inputs from participants of the event cause a representation of the event at a user terminal to be updated. A time period is defined, from detection of a first input, during which subsequent inputs are collated, and the representation is updated at the end of the time period to take into account a combination of all the detected inputs. Inputs and corresponding updates may be grouped together by type, and different types may be processed independently, with independent time periods, possibly running in parallel.

### TECHNICAL FIELD

The present disclosure relates to communication and collaboration over a network, and to enhancing communication over a network.

### BACKGROUND

Communication, and collaboration are key aspects in people's lives, both socially and in business. Communication, and collaboration tools have been developed with the aim of connecting people to share experiences. In many or most cases, the aim of these tools is to provide, over a network, an experience which mirrors real life interaction between individuals and groups of people. Interaction is typically provided by audio and/or visual elements.

Such tools include instant messaging, voice calls, video calls, group chat, shared desktop etc. Such tools can perform capture, manipulation, transmission and reproduction of audio and visual elements, and use various combinations of such elements in an attempt to provide a communication or collaboration environment which provides an intuitive and immersive user experience.

A user can access such tools at a user terminal which may be provided by a laptop or desktop computer, mobile phone, tablet, games console or system or other device for example. Such user terminal can be linked in a variety of possible network architectures, such as peer to peer architectures or client-server architectures or a hybrid, such as a centrally managed peer to peer architecture.

### SUMMARY

A communication visualisation environment can be created for representing participants in a shared user event such as a video call or video conference or presentation. In such an environment, different areas of a screen or display are typically used to represent participants. Participants of shared user events such as a video call can also share content as part of the event, such as documents or presentations for example. Such content may be displayed in conjunction with display areas representing participants of an event such as a video call.

With the aim of better reflecting the shared event, and allow better engagement and communication between participants, the size or position of display areas representing participants and/or content can be varied, in response to participant inputs or actions for example. Also, graphics or icons can be provided in or around display areas to reflect participant's expression or attribute states, again providing a more immersive user experience.

Thus it can be seen that collaboration systems and tools aim to capture multiple inputs and actions from multiple users in increasingly complex scenarios, and to reflect those inputs and actions in the visualisation environment of co-participants. However, this can potentially result in noise, which can be distracting or off putting, and prevent intuitive participation. It would be desirable to provide content and participant information in an improved manner, to make the experience more intuitive to users.

According to a first aspect there is provided a method for providing communication between participants of a shared user event comprising causing a display at a first user terminal to render a representation of content and/or participants in the shared user event; detecting a first input from a participant of said event; defining a time period beginning from detection of said first input; detecting at least one further input from a participant of said event, occurring within said defined time period; determining, at the end of said time period, an updated representation of content and/or participants in response to said first and at least one further inputs; and causing a display to render the updated representation.

In this way, multiple user inputs can be gathered or detected over a time period and a single update of the representation made in response to those inputs, as opposed to multiple updates corresponding to multiple inputs. This can prevent too many updates to the display occurring in quick succession, causing visual noise and making it difficult for a participant to engage with the event comfortably.

In embodiments, therefore, the method may further comprise controlling the display not to render an updated representation in response to said first and second inputs, until expiry of said time period. However, it should be understood that because the display is not rendered with an updated representation in response to said first and further inputs during said time period, does not mean that it is not rendered with an updated representation at all during this period. For example, if video is rendered as a representation of a participant, such video can continue to be displayed with updated displays at the screen refresh rate or the video frame rate for example.

Not all inputs received during said time period, considered in isolation, may cause any update in the representation, however such inputs may be considered in combination with other inputs to result in an update.

Inputs may be pre-defined, in order to be detected in terms of recognisable characteristics or conditions in certain embodiments. Therefore, an event or action of a participant may be considered to correspond to multiple different inputs in examples. A single instance of a user speaking for example, may give rise to both audio and video inputs, and depending on the parameters of speech and movement, can give rise to one or more defined further inputs having certain characteristics or conditions, such as audio over a certain volume threshold corresponding to an input, or a movement in a video input in a certain frame area corresponding to another input for example. While a response to one or more of such inputs—in terms of an updated representation—may be prevented in embodiments, a response to other inputs corresponding to the same event—possibly also in terms of an updated representation—may not.

Inputs having certain defined characteristics or meeting certain conditions can be considered to belong to the same input type in embodiments. An input type may be a narrow type including only inputs having the same defined characteristics or conditions, or may be classified more broadly, so that inputs meeting different characteristics or conditions are included in the same type.

Inputs may also be associated with a specific output or update type, or possibly more than one output or update type, for example a particular type of change to the representation of content and/or participants (which may be collectively referred to as media items), or to certain particular elements or graphic objects of the representation. Furthermore, more than one input may be related to an output type, in a many-to-many relationship.

Therefore, in embodiments it is possible for the time period to be associated with one or more particular input types, or output types. In such embodiments, a time period can be triggered by a first input corresponding to the relevant input or output type, and it is inputs which correspond to that same input or output type, detected during said time period, which are detected and on which the updated representation is based. Thus in embodiments inputs are filtered according to input or output type for the purposes of said updated representation.

In embodiments more than one-time period can be running in parallel. Therefore, time periods for different types of inputs and/or outputs can be triggered independently, and can overlap in time.

The duration of a time period may be predetermined, and may for example be dependent on an input or output type with which it is associated in embodiments. For example, longer or shorter time periods may be more appropriate for some types of updating of the representation than for others. In a particular example, a time period associated with rearranging representations of participants in a display based on participant activity may be different to a time period associated with updating edited content in a display.

In embodiments the method may further comprise determining the number of further inputs detected, and causing said display to render an updated representation in response to said determined number. Where the time period is associated with an input or output type, only detected inputs of the corresponding type or types may be included in the determined number in embodiments.

In embodiments the shared media event is live or conducted in real time. In one embodiment the shared media event is one of an audio/video call, a group chat, a presentation, a live document collaboration, or a broadcast, and a content item can be an electronic document in embodiments.

A first input may be a participant starting or stopping speaking in the shared user event, or a participant joining or leaving the shared user event in embodiments. A first input may also be a participant adding or removing a content item from a shared user event, or editing a content item in a shared user event, in embodiments. Content items may include any document, work product, electronic document, or written or graphic material which is graphically displayable as part of an event. Typical examples of content include a presentation or one or more slides of a presentation, at least a part of a word processing document, a spreadsheet document, a picture or illustration, video or a shared desktop view.

In one embodiment, said representation of content and/or participants in the shared user event includes a plurality of distinct display areas, each display area representing a participant or a content item of said shared user event, and, responsive to the first and at least one further input, the arrangement of display areas of the participants and/or content items is changed in the updated representation.

For example, rendering of said representation of content and/or participants may comprise arranging the position of content items or representations of participants of the shared media event on a display, relative to one other. In embodiments this may be within a two dimensional grid or 3d layered environment referenced as a “stage”. Such rendering may also comprise determining whether or not to cause content items to be displayed.

A first input may be a participant inputting an expression state to said shared user event in embodiments. User expressions may be personal expressions or feelings such as happiness or expressions of actions such as clapping or laughing. Expressions may also be of a state related to the shared media event, such as a state of being on mute for example. An expression state may be associated with a graphic object, and such a graphic object can be used to input the expression state, and may also be rendered or displayed at a user terminal in associate with a participant.

In embodiments, the representation of content and/or participants in the shared user event includes one or more graphic objects associated with an input expression state of a participant of said shared user event, and wherein, responsive to said first and at least one further input, a different graphic object, associated with a group expression state of a plurality of participants is rendered in the updated representation.

Content items may include any document, work product, electronic document, or written or graphic material which is graphically displayable as part of an event. Typical examples of content include a presentation or one or more slides of a presentation, at least a part of a word processing document, a spreadsheet document, a picture or illustration, video or a shared desktop view.

The above methods may be computer implemented, and according to a further aspect there is provided a non-transitory computer readable medium or computer program product comprising computer readable instructions which when run on a computer, cause that computer to perform a method substantially as described herein.

The invention extends to methods, apparatus and/or use substantially as herein described with reference to the accompanying drawings.

Any feature in one aspect of the invention may be applied to other aspects of the invention, in any appropriate combination. In particular, features of method aspects may be applied to apparatus aspects, and vice versa.

Furthermore, features implemented in hardware may generally be implemented in software, and vice versa. Any reference to software and hardware features herein should be construed accordingly.

### BRIEF DESCRIPTION OF THE DRAWINGS

Preferred features of the present invention will now be described, purely by way of example, with reference to the accompanying drawings, in which:

FIG. 1 illustrates schematically an example communications system;

FIG. 2 is a functional schematic of a user terminal;

FIG. 3 shows a display environment for a shared user event;

FIGS. 4a and 4b show another display environment for a shared user event;

FIG. 5 shows a portal object for monitoring a shared user event

FIG. 6 illustrates a method of collating or grouping inputs to a shared user event;

FIG. 7 show a further display environment for a shared user event;

FIG. 8 shows an example menu for a user input;

FIG. 9 illustrates graphic objects representing input user expressions;

FIGS. 10a and 10b show portal objects in different configurations.

### DETAILED DESCRIPTION OF EMBODIMENTS

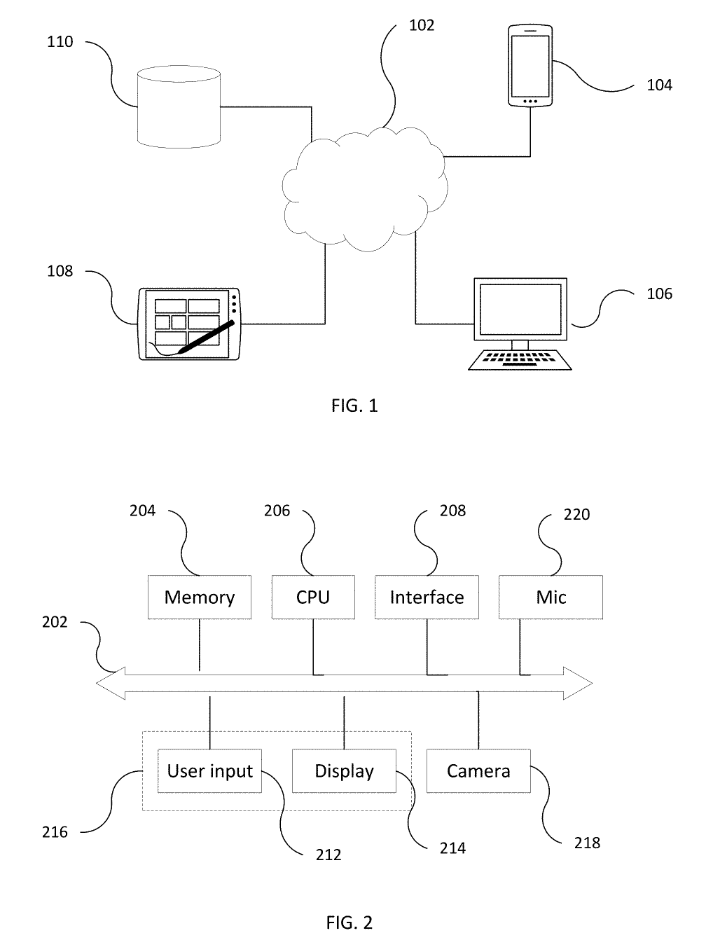

FIG. 1 illustrates an example of a communication system including example terminals and devices. A network 102 such as the internet or a mobile cellular network enables communication and data exchange between devices 104-110 which are connected to the network via wired or wireless connection. The network may be a single network, or composed of one or more constituent networks. For example, the network may comprise a wide area network such as the internet. Alternatively, or additionally, the network 102 may comprise a wireless local area network (WLAN), a wired or wireless private intranet (such as within a company or an academic or state institution), and/or the data channel of a mobile cellular network. In an embodiment a device is able to access the internet via a mobile cellular network.

A wide variety of device types are possible, including a smartphone 104, a laptop or desktop computer 106, a tablet device 108 and a server 110. The server may in some cases act as a network manager device, controlling communication and data exchange between other devices on the network, however network management is not always necessary, such as for some peer to peer protocols.

A functional schematic of an example user terminal suitable for use in the communication system of FIG. 1 for example, is shown in FIG. 2.

A bus 202 connects components including a non-volatile memory 204, and a processor such as CPU 206. The bus 202 is also in communication with a network interface 208, which can provide outputs and receive inputs from an external network such as a mobile cellular network or the internet for example, suitable for communicating with other user terminals. Also connected to the bus is a user input module 212, which may comprise a pointing device such as a mouse or touchpad, and a display 214, such as an LCD or LED or OLED display panel. The display 214 and input module 212 can be integrated into a single device, such as a touchscreen, as indicated by dashed box 216.

Programs such as communication or collaboration applications stored memory 204 for example can be executed by the CPU, to allow a user to participate in a shared user event over the network. As part of such participation, an object or objects can be output or rendered on the display 214. A user can interact with a displayed object, providing an input or inputs to module 212, which may be in the form of clicking or hovering over an object with a mouse for example, or tapping or swiping or otherwise interacting with the control device using a finger or pointer on a touchscreen. Such inputs can be recognized and processed by the CPU, to provide actions or outputs in response. Visual feedback may also be provided to the user, by updating an object or objects provided on the display 214, responsive to the user input(s). Optionally a camera 218 and a microphone 220 are also connected to the bus, allowing a user to provide inputs in the form of audio and/or video or still image data, typically of the user of the terminal. Such inputs can be transmitted to the network for reproduction at other user terminals. Such inputs may also be analysed, for example, by vision processing or audio analysis, to derive non video or audio inputs.

User terminals such as that described with reference to FIG. 2 may be adapted to send media such as audio and/or visual data, over a network such as that illustrated in FIG. 1 using a variety of communications protocols/codecs, optionally in substantially real time. For example, audio may be streamed over a network using Real-time Transport Protocol, RTP (RFC 1889), which is an example of an end to end protocol for streaming media. Control data associated with media data may be formatted using Real time Transport Control Protocol, RTCP (RFC 3550). Sessions between different apparatuses and/or user terminals may be set up using a protocol such as Session Initiation Protocol, SIP.

A shared media event is typically live, and data provided by participants or participant's terminals, such as text, voice, video, gestures, annotations etc. can be transmitted to the other participants substantially in real time. A shared media event may however be asynchronous. That is, data or content provided by a user may be transmitted to other participants for consumption at a later time.

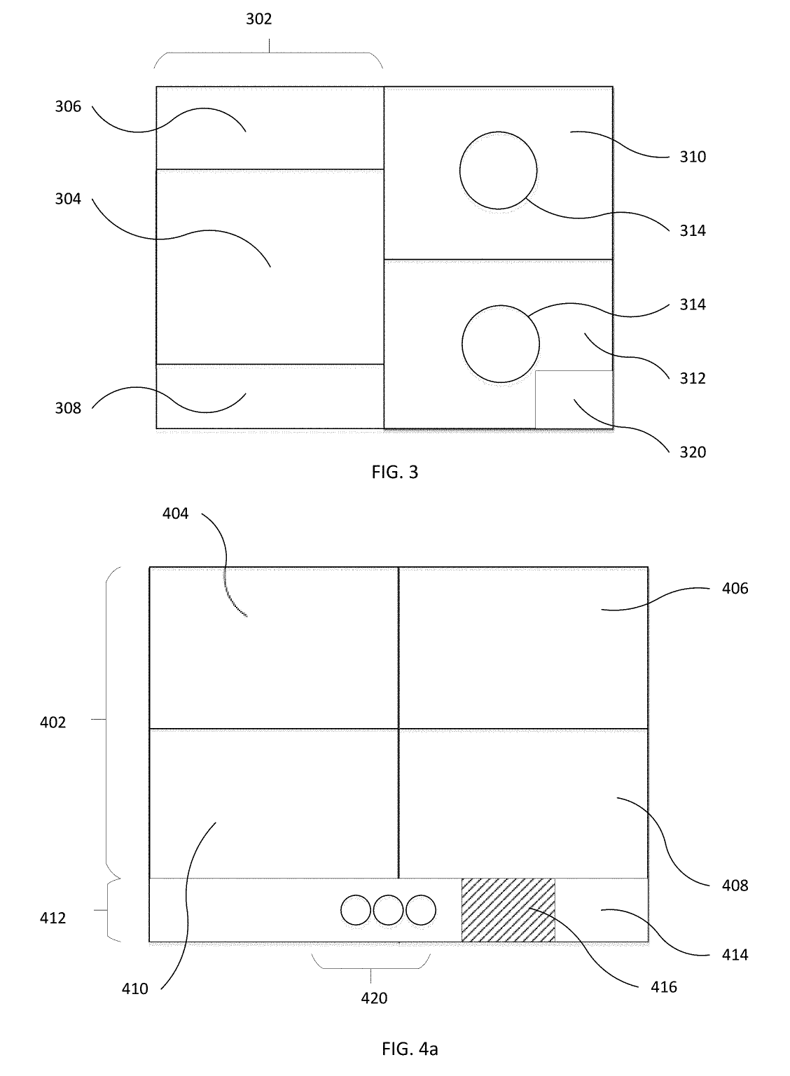

FIG. 3 illustrates a display provided to a participant of a shared media event, in this case a video/audio call.

It can be seen that a display or screen is divided up into different areas or grid sections, each grid section representing a participant of the call. Here the grid is shown with rectangular cells which are adjacent, but the grid cells may be other shapes such as hexagonal or circular for example, and need not be regular or adjacent or contiguous. On the left hand side of the screen, area 302 is assigned to a participant, and a video stream provided by that user is displayed in area 304 It can be seen that area 304 does not fill the whole grid section 302. In order to preserve its aspect ratio, the video is maximised for width, and background portions 306 and 308 exist above and below the video. The video may also occupy the whole edge to edge area of 302. Peripheral regions of video that don't contain activity may be cropped. Logic that determines face, movement or object location may be utilized to position and scale the video in each grid area.

The right hand side of the display is dived into two further rectangular grid sections 310 and 312. Each of these grid sections includes an identifier 314 to identify the participant or participants attributed to or represented by that grid section. The identifier may be a photo, avatar, graphic or other identifier. A background area surrounds the identifier. In this case, the grid sections on the right hand side represent voice call participants, and these participants each provide an audio stream to the shared event.

A self-view 320 is optionally provided in the lower right corner of the display to allow a user to view an image, type or video of themselves which is being, or is to be sent to other participants, potentially as part of a shared media event such as a video call. The self-view 320 sits on top of, and partially obscures, part of the background 312 of the lower right hand grid section

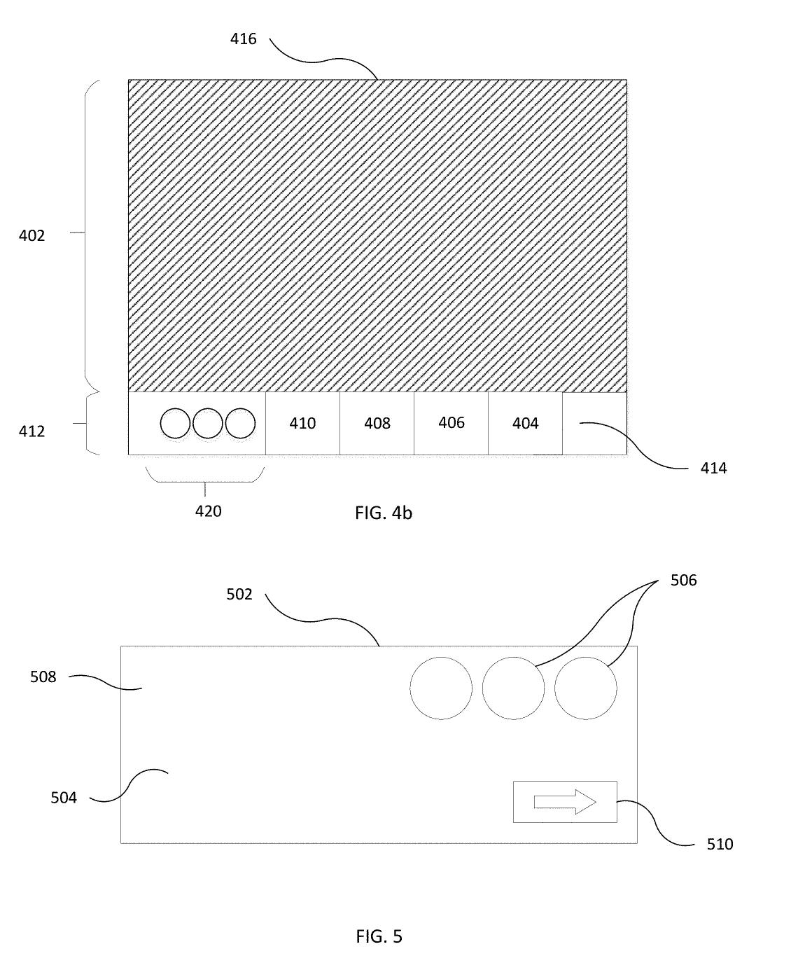

FIG. 4a illustrates another display provided to a participant of a shared media event. This grid exemplifies a “side by side” grid view where no overlay of people and content representation occurs.

The display again includes various grid sections. Here a main or upper portion of the display 402 (sometimes referred to an active stage) in this example includes four grid sections 404, 406, 408 and 410. These four grid sections each represent a participant to a shared user event, and display video of the respective participant, however one or more could represent an audio based participant, using an identifier such as identifier 314 of FIG. 3. Lower portion 412 of FIG. 4a (sometimes referred to as a passive stage or bottom row) of the display includes two further grid sections 414 and 416 arranged to the right hand side. The grid section 416 can be used to represent content or display video in a manner similar to the grid sections of the upper portion, albeit reduced in scale. Grid section 414 may be used to display a self-view. The remaining part of the lower portion 412 on the left hand side is used to display identifiers 420 of other, typically less active participants.

While an upper and lower portion have been described here, it will be understood that other arrangements are possible designating groups of display areas having different priorities, for example groups of display areas or grid sections in a side by side arrangement.

In the example of FIG. 4a, grid section 416 is used to display content, such as a presentation for example, shown shaded. Content may include any document, work product, or written or graphic material which can be displayed as part of an event. Typical examples of content include a presentation or one or more slides of a presentation, a word processing document, or a spreadsheet document, a picture or illustration, or a shared desktop view, user designated or system recognized hand writing or drawings, 3d or hologram, mixed reality or essentially any shared experience, virtual location, or media in embodiments. Multiple pieces of content, or multiple versions of a piece of content may be included in a given user event. In embodiments, content can be treated as a participant in terms of grid sections and display areas, and be displayed in place of a user video, or an identifier of a user. Content and/or participants may be collectively referred to as media items.

In the example of FIG. 4a, the different grid sections can be assigned to represent participants and/or content according to relative priorities. Grid sections in the upper portion 402 correspond to the participants or content considered or determined to be the most important, or highest status, while grid sections in lower portion 412, such as 414 and 416 correspond to lower status. Participants represented by identifiers 420 are lowest ranked in terms of status, and in this example do not have corresponding video (if available) displayed.

The display of FIG. 4a can be reconfigured as illustrated in FIG. 4b in certain circumstances. In FIG. 4b, the upper display portion 402 constitutes a single grid portion, and is used to display content, such as the content previously displayed at 416 of FIG. 4a. The structure of the lower portion 412 of the display of FIG. 4a is broadly similar to that of FIG. 4, with grid sections 414, 416 and 418 on the right hand side displaying video representing participants, and the left hand side used to display identifiers 420 representing participants.

It can be seen that in FIG. 4b, content occupies a portion of the display previously used to represent 4 participants when compared to FIG. 4a. In examples, these four participants are ‘moved’ to grid sections in lower portion 412. This results in more participants in the lower portion (assuming the total number of participants in the event remains the same) and it can be seen that the number of identifiers 420 is increased in comparison with FIG. 4a. If there are more participants than there is space for identifies, an identifier may simply indicate the number of further participants not shown. For example, “+3” would indicate three further participants.

In the examples of FIG. 4a and FIG. 4b, although grid sections along the lower portions 412, are of substantially equal size, an order of increasing priority from left to right is defined. Therefore, when content is demoted from the upper display portion, participants from that upper portion can be considered to be moved or demoted initially to the lower right grid section, and subsequently leftwards along the lower display portion, ultimately being represented only by an identifier, and not including or displaying video. Furthermore, grid sections or display areas can be grouped or tiered. A primary or top tier are the areas in upper display portion 402, and an intermediate tier are the display portions 414, 416, and a lower or bottom tier is the display area used to represent participants shown by identifiers 420.

When a participant joins a large group event, that participant will typically be represented in the lower tier, and may subsequently be promoted to be represented in a higher tier display area, for example if they are considered to increase in relevance, by beginning to speak or by adding or editing content in the shared user event. If a participant leaves an event, that person typically ceases to be represented, and other users or content may be promoted to be represented the grid section which has been made newly available. In a small group (5 participants or less) the joiner can join into the upper grid depending on the state of the group activity and the grid views available.

Other types of representation or visualisation of a shared user event are also possible, including a “monitor” type representation, which may be rendered on a user display, even if that user is not a participant in the shared user event. Such a representation may be provided as a portal object rendered on a display, and may provide a summary or overview of an event, and may be updated to reflect changes occurring inside the event. An example of such a portal object is shown in FIG. 5.

The portal object 502 has a background area 504 on which is superposed details including avatars (photo, video or initials) or objects 506 that represent and identify participants of the event. If too many participants are present, only a limited number can be displayed, and the number of further participants can be indicated in a single icon. For example, “+3” in a circle would indicate three further participants to those already indicated. Representations of participants can be updated to reflect users leaving and joining the event.

Text 508 can be used to indicate the name of the organizer or administrator of the event, and one or more activation objects 510 can be provided together with the portal object to allow a user to provide an input to perform a specific task relating to the event which the portal represents. For example, an activation object can be provided to allow a user to provide an input to become a participant of the event, or initiate processing to become a participant of the event. Advantageously, such an activation object can allow a user to become an event participant with a single input such as a click or tap.

Background area 504 can be used to provide an indication or visualisation of the content of the event to which the portal object relates. In the example where the shared event is a video call, content may for example include multiple video and audio streams corresponding to multiple different participants. Background area 504 may therefore display one or more of such video streams.

Thus content and/or participants can be represented in multiple different formats or arrangements, and such formats can be adapted to reflect their state or status, in the context of the shared user event, based on participant inputs or events. Such a change or update in format or arrangement may be considered separately from the actual substance of media displayed, such as video or presentation content, which may be dynamic and substantially continuously updated, at a display refresh rate for example

Formats or arrangements for representing content and participants can therefore be generated and updated in a display automatically, in response to rule based logic assessing the relative importance or priority of content and participants, based on participant behaviour. In one example, a “media stack” can be used which ranks each media item (e.g. content or participant) in terms of priority based on detected inputs or events. The representation of items, or layout or format of the display is changed or updated when a change in the order of the media stack occurs, so that the display reflects the stack.

Other rules and logic are possible, and rather than maintaining a whole priority sequence, certain inputs or events may automatically promote a participant. For example, if a participant begins speaking, that participant may automatically be moved to a more prominent display position. In a further simple example, if a participant leaves the event, that participant can be removed from the display.

Content and participants may however be rearranged manually if desired by a participant. In particular, a participant can choose to “toggle” content to have the highest priority, and conversely to be displayed in the, or a, main grid section or area of the display. This may occur if for example a user wishes to see the content more clearly and/or in greater definition. Content can similarly be “toggled” back to its original position if desired, freeing the or a main area or grid section to represent participants. Such rearrangement can override any automatic prioritisation.

A further way a user can control display of participants and content is by “pinning” such participants and/or content to specific display areas or sections. If a participant is pinned by a user to an active grid section such as section 408 of FIGS. 4a and 4b for example, this participant is locked in that position irrespective of any priority determination, and other contents and participants can be moved (promoted or demoted) around such spatially locked content, allowing a viewing participant persistent engagement with another participant or content.

Therefore, the layout or format of display can be semi-automated, based on input user constraints in addition to a rule based logic. At each change or update to the arrangement of the display, if control logic does not completely specify the arrangement of each item in the display (for example if it is only specified to promote one item) the remainder of the remainder of the items are adjusted automatically, to accommodate such a change.

As noted above, with multiple participants, and multiple inputs and/or events causing a representation or visualization to be updated, changes can occur rapidly, making it difficult or confusing for a user to follow or understand a communication event.

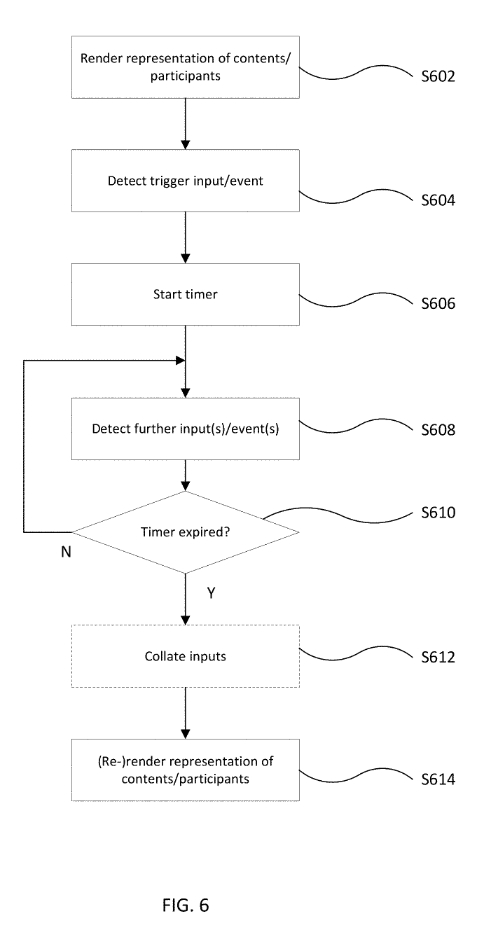

FIG. 6 is a flow chart illustrating a method of collating or grouping inputs or events of participants, and changing or updating a representation in response to such grouped or collated. The method of FIG. 6 may be implemented in a network architecture such as that illustrated in FIG. 1 for example, at a server or cloud service provider, at a client terminal or device, or a combination of these, in a distributed fashion.

At step S602 a representation of the contents and/or participants of a shared user event is rendered, such as that shown in FIGS. 3-5 for example. Various factors may affect the format or layout of the representation, as discussed above.

At step S604, a first input or event (a trigger input or event) is detected. Examples of events and inputs will be discussed below in greater detail, but generally speaking an input may in examples be any type of detectable activity or input of a participant, which may cause a change or update in the format or representation of content and/or participants.

In response to detection in step S604, a counter or timer is started at step S606. The duration of the timer may be pre-determined or may be set dynamically as will be discussed below. The duration of the timer may depend on the type of trigger detected in step S604. The timer defines a period over which multiple inputs or events, possibly from multiple different participants are detected, so that a collective response can be made to those inputs.

At step S608, further inputs or events (if any) are detected. This stage is effectively a monitoring stage, and all inputs or events from any and all other participants may be monitored or detected. Alternatively, only certain types of inputs or event s may be monitored, corresponding to or related to the initial input detected at S604. Detected inputs can optionally be stored for later use or processing.

At step S610 it is determined whether the timer has expired. If it has not expired (N) then the process returns to S608 to detect further inputs. If the time has expired (Y), then the process proceeds to step S612. Here the input received at S604, and other inputs received at S608 are collated. The combined effect of the inputs on the representation rendered at S602 can be determined, and a change or update to the representation can be determined based on the combined effect. At step S614 an updated representation is (re-) rendered based on the inputs and events detected at S604 and S608.

It is noted that step S612 is drawn dashed line as this step can be performed between steps S608 and S610. For example, as each input is received or detected at S608, its effect on the representation may be determined, which representation is continuously updated, until the timer expires. The final update is then rendered at step S614. Alternatively step S612 may be merged with step S614 with stored inputs processed together at the time of rendering the updated representation(s).

Examples of inputs or events which may trigger a change of the format or layout of participant or content representations will now be described.

An input may in examples be any type of detectable activity or input of the participant. For example, the activity or input can be detected by a camera such as camera 218 or a microphone such as microphone 220 of the user terminal of FIG. 2. Input can also be detected from a user input device such as input device 212 of the user terminal of FIG. 2, which may be a keyboard or touchscreen for example.

Considering audio or voice activity, a type or degree of activity can be distinguished, as determined by parameters such as volume, duration, signal level change, or duration of signal change for example. Similarly, for visual activity, types of physical posture, expression or movement of a user or users can be determined, for example by an image processing algorithm applied to pixel based image signals to detect differences in successive frames.

In one example, an input is determined as a participant beginning to speak after a period of audio inactivity, or conversely a participant stopping speaking, after having been talking. To determine such inputs, and distinguish over brief pauses, or background noise such as coughing, filters and algorithms can be used to process an audio input from a participant. This input or event, of stopping and starting speaking is sometimes referred to as a “stand up/sit down” event, in reference to a face to face meeting where participants may stand to speak.

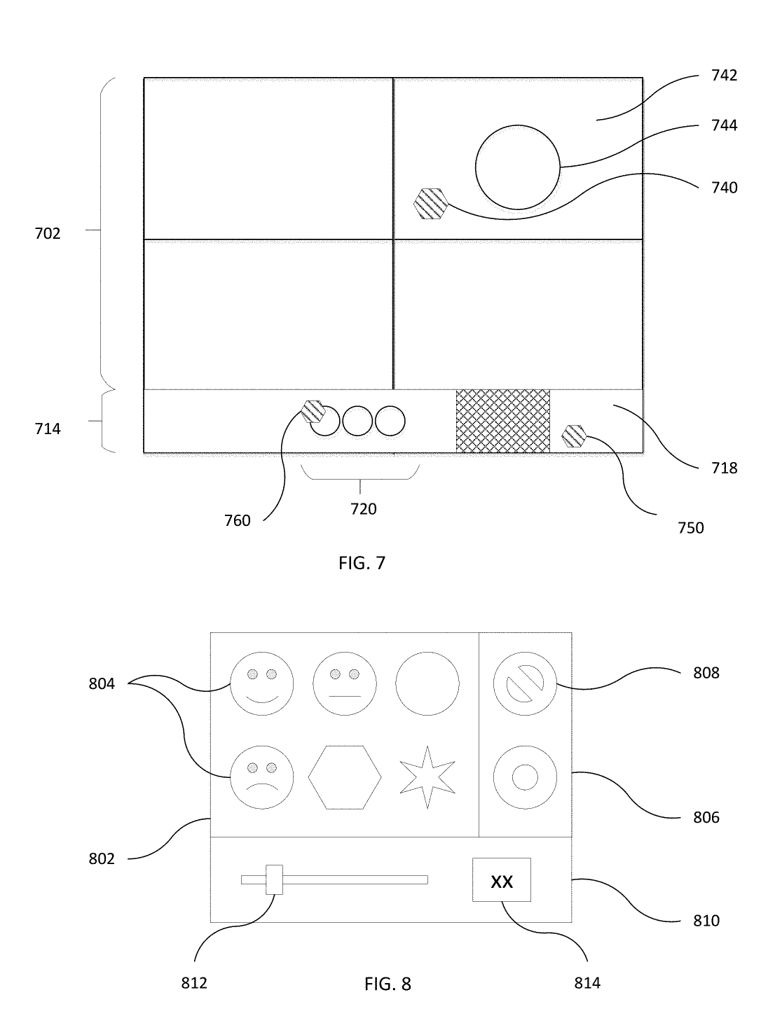

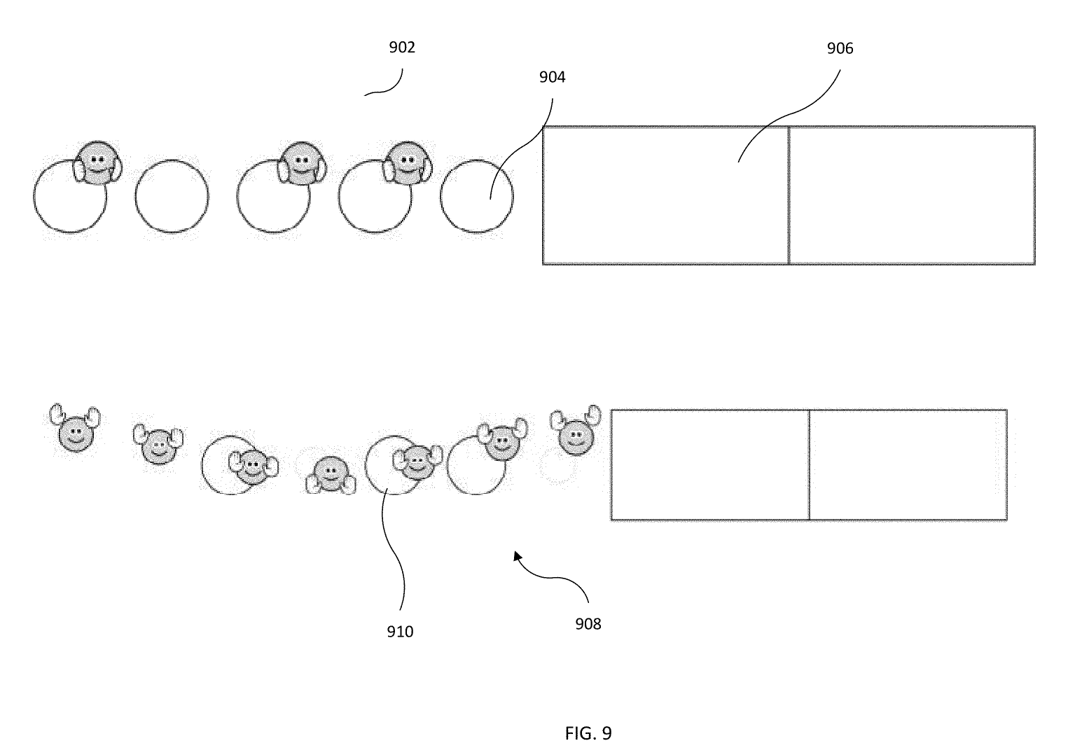

A further type of activity is text input or other input from a device such as a keyboard or mouse or other pointing device. Such input may be input of symbols or icons as described with reference to FIGS. 7 and 8 described below for example, or movement of a pointer on a screen. The input may be in relation to content shared as part of the communication event, such as a presentation. The input may be the sharing or uploading of that content item, or updating or editing of that item or media, possibly in the native application. Any system recognized update to the current status of that shared content can be considered as an input.

The state of a participant in relation to the communication event may also be used as a type of activity which may result in display update. An input corresponding to joining or leaving a shared user event can be taken into account for example, and may be referred to as a “join/leave” event. Events relating to other so called “attribute states” reflecting a user's communication status, such as a muted state, may also be used as inputs.

Considering an example of a stand/sit input, in relation to FIG. 6, a “stand” event performed by a participant in a shared user event is detected when that participant starts to speak. This can be detected or recognized by a server or central processor (e.g. cloud service provider), or by a client terminal of another participant or participants of the event. In response a timer is started. In examples, multiple timers may run concurrently, based on different detected trigger inputs or events. In this case a timer for stand/sit events is started.

Typically, a detected “stand” input might cause an update in the representation of other participants, to promote the speaker from a passive display area to a main area, such as from area 420 to area 408 in FIG. 4 for example. Here however, no such update is performed until the timer expires. During the timed period, other events and inputs from all participants are monitored. Because a stand event has been detected, other stand/sit evens are monitored for the duration of the timer. Only such events can be monitored, or all events can be monitored, but the results filtered for stand/sit events.

Further detected events may give rise to further changes in the format in which the content or participants are, or would be, represented, however it is only when the time period ends that the final format, reflecting all of the detected events, is rendered to a participant.

Therefore, multiple inputs which might otherwise result in multiple changes of format or layout of representations, possibly in rapid succession, are instead reflected in a single change of output format. This reduces visual noise, and makes it easier for participants to follow dialog or communication

It is noted that not all participants will have the same representation(s) rendered. Therefore, a timer and final rendering may be effected independently for each participant, or the client device or terminal of each participant.

A similar example relating to a join/leave event can be considered, when it is detected that a participant leaves a shared user event. This would typically remove the corresponding representation (if any) from the displays of other participants. In this case however, a join/leave timer is started, and for the period of the timer it is determined whether any other participants join or leave the shared event. In an example two more participants leave the shared event during the time period. Instead of the representation being updated as each person leaves, it remains stable during the period of the timer, and subsequently the representation is re-rendered reflecting the departure of all three individuals, reducing visual noise or disruption.

Both of the above described examples (stand/sit and join/leave) result in the possible rearrangement of representations of participants on a display. Therefore, in examples it is possible to merge the timers and/or processing for such events. Alternatively, a master timer can be used, preventing the rearrangement of participants until both stand/sit and join/leave timers have expired.

In such cases, the time period, and associated processing and re-rendering is associated additionally or alternatively with the output in terms of the type of change or update to the representation(s) which result. An example of such a type is the rearrangement of representations, or a reordering of the “media stack” as described above. Thus a timer, or time period may be used to collate or group inputs or events related to a defined type of change in the representation(s).

Another example of an input which may result in a similar type of output is content related inputs, for example the adding or removing of content from a shared user event. This may involve uploading content into the event, by one or more participants, or conversely removing content from the event. For content already included in an event, edits applied to the content may also be considered. All of these activities may give rise to changes in the way that content is represented to a participant, in a similar manner to the stand/sit and join/leave cases considered above. Edits to a document from one or more participants may promote that document to a higher priority grid area for example, while a participant introducing multiple content items into a shared user event, possibly sequentially, may cause representations to be rearranged. Therefore, such activities can also be merged together or considered under the control of the same master timer.

A further example again concerns inputs relating to content items, but which may result in a different type of output. Editing of a content item, such as a word processing document in a shared user event, by one or more participants may be considered both in terms of how to represent that content in a display, and in terms of displaying changes to the content itself. The former has been considered above, but the latter results in a different type of output, from the perspective of updating or re-rendering a representation of the content item. Therefore, in respect of the latter, separate processing may be applied, and a separate timer run. Therefore, a single event or input, such as editing a document, may result in two or more timers and corresponding processing being run in parallel, each timer and process corresponding to a different output type

For the purposes of displaying edited content then, a timer may be started by a first editing action performed by a participant, and during the timed period, other editing inputs from participants are monitored. When the timer expires, the representation of the content item is re-rendered, on the basis of all the edits received during the time period. Again this provides the advantage of reducing visual noise, or “jitter”, and resulting in a smoother experience for a user.

The duration of the time period or time periods may be pre-determined in instances. A further possibility is for the time period to depend on the input type, or on the type of output caused by that input, in terms of the updating or re-rendering of representations caused. Considering the examples described above, an initial input of a stand/sit event may commence processing and a timer specifically directed at all stand/sit events for the duration of that time period, and similarly, a join/leave event may have a different time period and corresponding processing. In this case, the two types of inputs and processing resulting from those inputs run substantially independently. Alternatively, the output type for such events may be considered, such as an output to cause the layout of participants and/or content within a grid display to be rearranged. In such a case a time period may be defined or set for such an output type, such that at expiry of the set period, the output is performed, based on all inputs during that period which contribute to that output type.

Values may be of the order of milliseconds if required, for example 10 milliseconds or 50 milliseconds, or may be of the order of seconds in other circumstances, for example, approximately 0.5 seconds, 1 second, 2 seconds or 5 seconds. It is possible for the time period to be linked to a display refresh rate in some cases.

FIG. 7 illustrates a further way in which a representation of a content or participant can be generated and updated to reflect the status of that participant or content in the context of the shared user event, based on participant inputs or events

The display of FIG. 7 is largely similar to the display of FIG. 4 including multiple representations of participants of a shared user event such as a video call. In addition, to audio or video received by such a participant, an indication of a user expression or expressions can be received, and such expressions or representations thereof can be displayed. A graphic object, animation or icon representing such a state is illustrated by shaded hexagon 740. The graphic object or icon is located at or adjacent the grid section representing the participant to which it relates or was input by. In this way it can be easily seen which expression (if any) corresponds to which participant. In this case, the graphic object is located in grid section or display area 742, corresponding to a participant identified by identifier 744. This allows a participant to communicate without verbally interrupting a speaker.

FIG. 8 shows an example menu 802 which may be used by a participant of a shared user event to provide an input representing a user expression or state. A plurality of predefined graphic objects such as symbols, animations or icons 804 are displayed, each graphic object representing a user expression. User expressions may be personal expressions or feelings such as happiness or expressions of actions such as clapping or laughing, or raising a hand to communicate a desire to say something to the speaker. Expressions may also be of a state related to the shared media event, such as a state of being on mute for example. Here different faces are shown as examples, but any type of graphic object can be used, as represented by star hexagon and circle shapes. A user is able to select a symbol by tapping or clicking on it for example, using an input device such as 212 of FIG. 2. Menu 802 optionally also includes a section 806 containing icons or graphics 808 representing inputs which are not related to a user expression, but instead relating to another aspect of the communication environment such as camera, attribute or audio settings for example. Examples of expressions are provided as follows:

User emotion or sentiment—Applause/clapping; good bye; agree; disagree; be right back; raise your hand; can't see (no video); can't hear (no audio); dancing/celebration.

User attribute—Mute, pin, hold.

An optional section of the menu 810 allows a user to input a time period. The time period is to be associated with a selected graphic object 804, and can be input via a slider bar 812 and/or a text input box 814 for example. A default time period may be set and displayed, and if a user does not change the default value or input a different time period, that default is associated with a symbol subsequently selected.

Returning to FIG. 7, graphic objects can similarly be displayed for participants viewed or represented in lower or passive portion 714 of the display. For example, an expression of a participant represented by grid section 718 is displayed by object 750 in the bottom corner of the grid section. The state of a participant represented by one of the identifiers 720 is displayed by object 760 shown partially overlapping the relevant identifier.

In an example therefore, a participant in an event such as a videoconference may like or agree with what another presenter is currently saying or showing. The user can bring up a menu such as menu 802 and select an expression representing an agreement, such as a “thumbs up” symbol. The user then provides an input to send or submit the expression. Information representing the expression is sent to other participants, and where another participant has the sender represented on a display (for example as part of a display grid showing video from the sender, or an identifier for the sender for the purposes of identifying an audio based participant) the relevant symbol, which is the thumbs up symbol in this case is displayed on or adjacent to the representation. The symbol continues to be displayed while other audio or video may be ongoing, for the set duration, and after that duration expires, the symbol stops being displayed.

As with the arrangement of representations, graphic objects described above provide another example of a display format which can be adapted to reflect the state or status of a participant, in the context of the shared user event, based on or responsive to participant inputs or events. Similarly, therefore, a collective response can be made to inputs representing user or participant expressions aggregated or accumulated over a time period.

FIG. 9 shows at 902 three instances of a graphic object representing a clapping or applause expression input, from three different participants, optionally input at three different times.

For example, the three individual graphic objects may be input from three users represented at 720 of FIG. 7 resulting in a single graphic object being displayed adjacent three of the five identifiers 904 shown, equivalent to the single instance shown at 760 of FIG. 7. Rectangles 906 are included only for context, and may represent a self-view and a content, or dominant speaking video for example. As a result of three such inputs, in relation to a defined time period, the three inputs are instead represented by an animated “group expression” or “crowd wave” object as illustrated at 908. The group expression object may be displayed adjacent or overlying the identifiers in this example. In this case, the identifiers 910 of participants that triggered crowd wave expression stay in their current position while the identifiers of participants that did not contribute to part of the group expression are reduced in scale and/or opacity to visually separate them from the group expression, “crowd wave.” It will be understood however, that in examples, an individual expression input may originate from a participant represented in the main region 702 (e.g. expression 740), or a region such as 718 (e.g. expression 750) both with reference to FIG. 7, or not currently represented. Therefore, a corresponding group expression object may be displayed or located at a variety of possible positions accordingly, such as area 702, 718 or 714 or a combination, in the example of FIG. 7. It will be understood that this extends to other display formats, and that a group expression may be displayed or located at substantially any position of a display such as FIG. 3 or FIG. 4a or 4b.

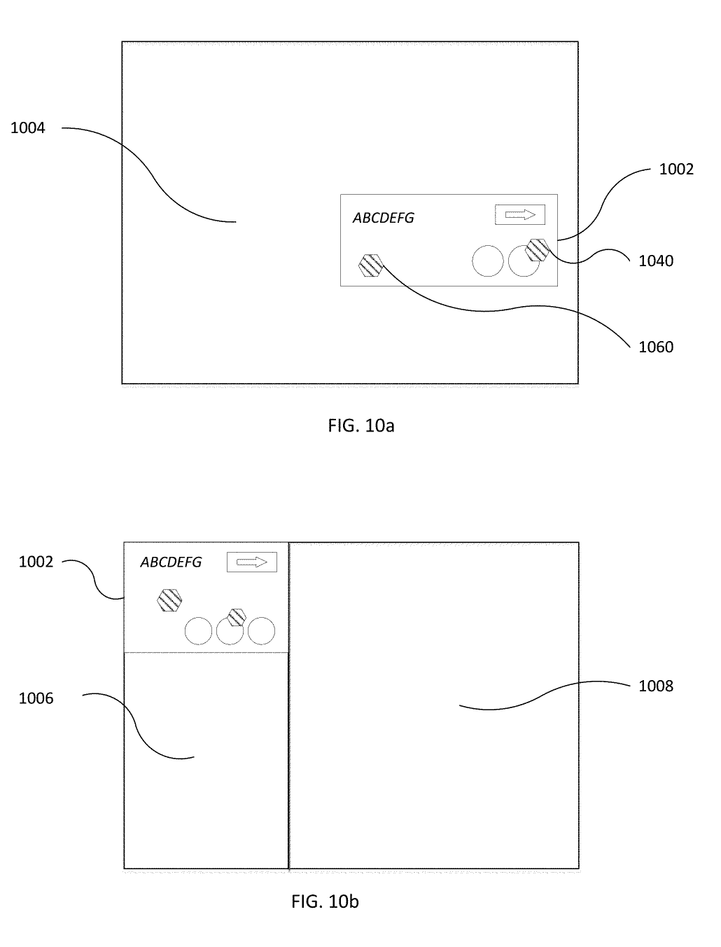

A group expression may also be displayed in relation to an event represented by a monitor such as the monitor illustrated in FIG. 5. FIGS. 10a and 10b show examples of a portal object in two different configurations. In FIG. 10a, the portal 1002 is “floating” on a desktop 1004 which is being presented or shared with other participants. As in FIG. 5, representations of participants can be shown in the lower right corner (in this example) and as shown at 1040, a graphic object indicative of an expression can be provided linked to one or more such representations. Also as per FIG. 5, the background or main area of the portal can be used to provide video or images of a participant, or content related to the event, and a graphic symbol liked to such a participant or content can be shown at 1060. Combinations of expressions (or corresponding inputs) represented by such graphic objects 1040 and 1060 can be detected and collated, and a group expression object rendered, on or otherwise linked to the portal.

In FIG. 10b, the portal 1002 is shown “docked”, and a pane 1008 can be used for chat or channel content or messages, and a pane 1006 can be used for other purposes, such as a list of contacts for example. In an equivalent way to FIG. 10a, the portal can include graphic objects indicative of expressions, and such graphic objects can be re-rendered as group expression objects or animations as appropriate.

A group expression object need not be animated, and could for example be of a larger size, or simply a different shape, design or colour to distinguish over an individual input.

Considering the example described above in relation to FIG. 6, at step S602 a representation or representation(s) of contents and/or participants are rendered, possibly including one or more graphic objects as described above. In step S604 a trigger input is detected, as an input by a participant of a user expression, or an input of a graphic object representing a user expression. The expression may be of a personal emotion or sentiment, or of a communication state such as muted or on hold for example.

At step S606, a timer is started. The timer may relate to a specific graphic object or expression type, such as a clapping expression or a thumbs up expression for example. Alternatively, the timer may relate to a group of expressions that may wish to be considered jointly, such as can't see and can't hear expressions, both being considered as a type representing an incomplete media state for example.

As discussed above, a timer period may be predetermined, and may depend on the type of expression input or output related to that input. Again, time periods of milliseconds are possible, however it has been found to be more useful for time periods in such examples to be of the order of seconds, for example approximately 1 second, 2 seconds 5 seconds or 10 seconds.

At step S608 further inputs are detected, while the timer is running. As noted above, an expression input may itself have a time period associated, as indicated at 810 of FIG. 8 for example. Therefore, this detection may refer to only expression inputs received during the timer period, or may also include expressions inputs still active during the timer period. All expression inputs may be detected, and filtered for inputs relative to a particular timer, or consider a particular timer, only inputs of the associated type may be detected.

At step S610 it is determined whether or not the timer has expired, substantially as described before, and if not, then monitoring or detection at step S608 continues. If the timer has expired, detected inputs are collated at step S612, and representation(s) re-rendered at Step S614, possibly re-rendering to include a group expression object.

In the case of expression inputs, and group expressions, an additional factor of the number of inputs may be considered. For example, the number of inputs of a particular type, representing the number of participants expressing that input type, may be compared to a threshold number to determine an output or response. For example, a group expression may be rendered only if a sufficient number of inputs of a specified type or types are detected within the timer period. The threshold may be a fixed number, such as five or ten inputs, or may be determined as a percentage of participants, e.g. 10% or 25% or 50%. Furthermore, if a threshold number of inputs is received during a timed period, the appropriate group expression may be rendered before the time period has expired. Thus the determination of the number of inputs may override the, or a, timer.

In examples, different group expression graphic objects may be rendered depending on the number of inputs, or that graphic object could be varied by size or colour to reflect the number of inputs. For example, if an input representing approval is detected five times, a graphic of a first type may be rendered, and if subsequently a further five such inputs are detected, the size of the graphic is increased. The subsequently detected inputs may occur with the original time period, or the detection of a threshold number may trigger a new timer.

It is noted that in the case of expression inputs, graphic objects representing individual inputs may be rendered while the timer is still running, unlike some scenarios described above in relation to rearrangement of a participant grid for example. This may be useful to still allow those expressions to be communicated if a threshold number of inputs has not (yet) been received. If it is determined at the point of timer expiry that a group expression object is to be rendered, this may take the place of one or more individual expression objects.

Considering a specific example, during a shared user event such as a presentation or video call, one or more participants may input an expression, indicating that they cannot receive audio (can't hear) possibly due to connection or network problems, or due to an incorrect setting by the presenter. The first such input triggers a timer, which in this example may be 20 seconds. A threshold number of inputs may be set at 40% of the total number of participants, and if during the time period of 20 seconds the number of “can't hear” inputs reaches or exceeds that threshold, a group expression object is rendered on the display of the presenter (and optionally on the display of all participants, indicating a group state of low or no audio This could be a large graphic displayed prominently, in the centre of a display for example, to immediately draw attention to the presenter and prompt him or her to take action to correct the problem.

It will be understood that the present invention has been described above purely by way of example, and modification of detail can be made within the scope of the claims. Each feature disclosed in the description, and (where appropriate) the claims and drawings may be provided independently or in any appropriate combination.

The various illustrative logical blocks, functional blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the function or functions described herein, optionally in combination with instructions stored in a memory or storage medium. A described processor may also be implemented as a combination of computing devices, e.g., a combination of a DSP and a microprocessor, or a plurality of microprocessors for example. Conversely, separately described functional blocks or modules may be integrated into a single processor. The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, and a CD-ROM. As recited herein, computer readable media do not include signals per se.

1. A method for providing communication between participants of a shared user event comprising:
causing a display at a first user terminal to render a representation of content and/or participants in the shared user event;
detecting a first input from a participant of said event;
defining a time period beginning from detection of said first input;
detecting at least one further input from a participant of said event, occurring within said defined time period;
determining, at the end of said time period, an updated representation of content and/or participants in response to said first and at least one further inputs; and
causing a display to render the updated representation.

2. A method according to claim 1, further comprising controlling said display not to render an updated representation in response to said first and at least one further input, until expiry of said time period.

3. A method according to claim 1, wherein said first input is classified according to an input type, and said time period is associated with that input type.

4. A method according to claim 3, wherein said at least one further input is of the same input type as said first input.

5. A method according to claim 3, comprising defining more than one-time period running in parallel.

6. A method according to claim 5, as dependent upon claim 3, wherein different time periods correspond to different input types.

7. A method according to claim 3, wherein duration of the time period is dependent on said first input or said first input type.

8. A method according to claim 1, further comprising assessing the number of further inputs detected, and causing said display to render an updated representation in response to said number being greater than or equal to a threshold.

9. A method according to claim 1, wherein said shared media event is live or conducted in real time.

10. A method according to claim 1, wherein said shared media event is one of an audio/video call, a group chat, a presentation, a live document collaboration, or a broadcast.

11. A method according to claim 1, wherein said first input is a participant starting or stopping speaking in the shared user event, or a participant joining or leaving the shared user event.

12. A method according to claim 1, wherein said first input is a participant adding or removing content from a shared user event, or editing content in a shared user event.

13. A method according to claim 1, wherein said representation of content and/or participants in the shared user event includes a plurality of distinct display areas, each display area representing a participant or a content item of said shared user event, and wherein, responsive to said first and at least one further input, the arrangement of display areas of said participants or content items is changed in the updated representation.

14. A method according to claim 1, wherein said first input is a participant inputting an expression state to said shared user event.

15. A method according to claim 1 wherein said first input comprises selection of one or more graphic objects associated with an input expression state of a participant of said shared user event, and wherein, responsive to said first and at least one further input, a different graphic object, associated with a group expression state of a plurality of participants is rendered in the updated representation.

16. A method for providing communication between participants of a network based audio/video shared user event, said method comprising:
causing a display at a first user terminal to render a representation of content and/or participants in the shared user event;
detecting a first input to said shared user event, from a participant of said event at a second user terminal, which first input can be represented by a graphical change of a first aspect of said representation at said first user terminal;
controlling the display at said first user terminal not to render an updated representation in response to said first input;
waiting for a defined period from detection of said first input;
detecting at least one further input from a participant of said event, occurring within said defined time period, said at least one further input capable of being represented by a graphical change of the first aspect of said representation;
determining, at the end of said time period, an updated representation of content and/or participants, said updated representation responsive to the combination of said first and at least one further inputs; and
causing the display at the first user terminal to render the updated representation.

17. A method according to claim 16, wherein said first input causes an updated order of priority of said represented participants or content items, and said graphical change of said first aspect is the re-arrangement of a plurality of distinct display areas, each display area representing a participant or a content item of said shared user event.

18. A method according to claim 16, wherein said graphical change of the first aspect comprises rendering of one or more graphic objects associated with an input expression state of a participant of said shared user event, and wherein, responsive to said first and at least one further input, a different graphic object, associated with a group expression state of a plurality of participants is rendered in the updated representation.

19. A computer readable storage medium comprising computer readable instructions which, when run on a computer, cause that computer to perform operations comprising:
causing a display at a first user terminal to render a representation of content and/or participants in the shared user event;
detecting a first input from a participant of said event;
defining a time period beginning from detection of said first input;
detecting at least one further input from a participant of said event, occurring within said defined time period;
determining, at the end of said time period, an updated representation of content and/or participants in response to said first and at least one further inputs; and
causing a display to render the updated representation.

20. A computer readable storage medium according to claim 19, wherein the operations further comprise controlling said display not to render an updated representation in response to said first and at least one further input, until expiry of said time period.
